(19) United States
(12) Patent Application Publication
(10) Pub. No.: US 2026/0178715 A1
(43) Pub. Date: Jun. 25, 2026

(54) Authentication and efficient monitoring of remote users during creation of high-value electronic documents Authentication and efficient monitoring of remote users during creation of high-value electronic documents

(71) Applicants: Greg N. Sarab, Half Moon Bay, CA (US); Alexa J. Fanti, Reisterstown, MD (US)

(72) Inventors: Greg N. Sarab, Half Moon Bay, CA (US); Alexa J. Fanti, Reisterstown, MD (US)

(21) Appl. No.: 18/991,337

(22) Filed: Dec. 20, 2024

Related U.S. Application Data
(63) Continuation of application No. 17/462,303, filed on Aug. 31, 2021, now abandoned.
(60) Provisional application No. 63/072,792, filed on Aug. 31, 2020.

(51) Int. Cl. G06F 21/32; G06V 20/52

(52) U.S. Cl. CPC G06F 21/32; G06V 20/52

(57) ABSTRACT

Methods, systems, and apparatus for the effective authentication and efficient monitoring of remote examinees during examination periods are disclosed.

### RELATED APPLICATIONS

The present application claims priority to U.S. Provisional Patent Application No. 63/072,792 filed on Aug. 31, 2020; incorporated herein by reference in its entirety.

### FIELD

The present teachings relate to the computer-based creation of high-value electronic documents, such as examinations; and more particularly to the authentication and efficient monitoring of remote users during creation of such documents.

### BACKGROUND

Prior efforts at monitoring remote examinees during timed examinations have included making a continuous video of the examinee and/or the screen (desktop) of the examinee's computer used in taking the examination. Typically, creation of the video would begin at the outset of the examination period and continue without interruption until the end of the examination period. Such lengthy videos, however, are resource intensive with regard to: (i) the operation of the computer or other device on which it is made; (ii) the transmission of large files by upload or other means; and (iii) for human proctors and/or examination reviewers/graders who must review the videos towards ensuring the integrity of the testing environment and minimizing the possibility of cheating.

### SUMMARY

The present teachings provide methods, systems, and apparatus for the effective authentication and efficient monitoring of remote examinees during examination periods.

Various aspects of the present teachings relate to methods for authentication and efficient monitoring of a remote examinee during creation of a high-value electronic document for a computer-based examination. According to various embodiments, such methods can comprise the steps, for example: (a) prior to start of the examination, capturing authentication data by a test-taking computer of the examinee; wherein the authentication data includes (i) a digital photo of the examinee and (ii) a digital photo of a photo identification (ID) showing the examinee; (b) transmitting the captured authentication data to an authority for the examination for verification; (c) during the examination, capturing proctoring data by the test-taking computer of the examinee at random time intervals, wherein the proctoring data includes (i) plural still-image captures of the computer desktop of the examinee's test-taking computer; and, (ii) plural photos of the examinee and the examinee's physical environment for taking the examination; wherein the examinee's test-taking computer is equipped with a camera for capturing the still images, and (d) transmitting the proctoring data to a designated server of the examining authority for review.

In various embodiments, step (b) is carried out after the examination has finished.

In various embodiments, step (d) is carried out during the examination.

In various embodiments, a video is made during the examination. For example, in various embodiments, the method can further comprise recording continuous or intermittent video using a video-capable camera of the test-taking computer.

In other various embodiments, no video is made during the examination.

In various embodiments, the method can further comprise storing the recorded video as one or more electronic files only locally on the test-taking computer, and keeping the stored video file(s) there, unretrieved by any person, for a designated period of time, except only in the event the examining authority requests to receive the video file(s), then the video file(s) are accessed by the examinee for transmission to a designated server of the examining authority.

In various further embodiments, a method for authentication and efficient monitoring of a remote examinee during creation of a high-value electronic document for a computer-based examination can comprise the steps, for example: (a) prior to start of the examination, capturing authentication data by a test-taking computer of the examinee; wherein the authentication data includes (i) a digital photo of the examinee and (ii) a digital photo of a photo identification (ID) showing the examinee; (b) transmitting the captured authentication data to an authority for the examination for verification; (c) during the examination, capturing proctoring data by the test-taking computer of the examinee at random time intervals, wherein the proctoring data includes (i) plural still-image captures of the computer desktop of the examinee's test-taking computer; (ii) plural photos of the examinee and the examinee's physical environment for taking the examination; (iii) optionally, continuous or intermittent video recording; and/or (iv) other sensor data; and wherein the examinee's test-taking computer is equipped a camera for capturing the still images, and (d) transmitting the proctoring data to a designated server of the examining authority for review.

### BRIEF DESCRIPTION OF THE DRAWING(S)

FIG. 1 depicts, in flow chart format, a method for authentication and efficient monitoring of a remote examinee during creation of a high-value electronic document for a computer-based examination; according to various embodiments of the present teachings.

### DESCRIPTION

According to various embodiments, an exam monitoring device is co-located with an examinee at a remote examination site. The device can comprise, for example, a computer for use by the examinee in taking an examination. The computer is programmed to make proctoring data, which can include, for example, making plural still-image captures of the examinee's computer desktop during the examination. An image of the desktop can be captured, for example, in real time, continuously, and/or periodically. In various embodiments, an image of the examinee's computer desktop is captured periodically, wherein the periodicity is (i) random, (ii) scheduled, (iii) responsive to a trigger event, or (iv) any combination thereof. Examples of trigger events can include actions taken by the examinee and/or computer-based events. (See, e.g., U.S. patent application No. 20070117082 A1; incorporated herein by reference.)

In various embodiments, an exam monitoring device can further comprise a personal mobile device, such as a mobile phone comprising one or more sensors (e.g., a camera). In various embodiments, a mobile phone supplements a test-taking computer as an exam monitoring device.

In various embodiments, an examination is timed and remotely proctored (e.g., a state bar examination). Remote proctoring of the examination can include, for example, periodically, randomly, and/or intermittently utilizing one or more sensors of the examinee's computer, such as a front-facing camera (e.g., webcam), a microphone, a global positioning system (GPS) module, a fingerprint reader, and the like to collect proctoring data. The collected proctoring data may or may not be collected at a set period and may be randomly and intermittently collected such that the examinee is unaware of when information is being collected. In various embodiments, users are made aware of and have provided consent regarding proctor-data gathering (e.g., biometric, audio, visual, and/or other data) prior to the commencement of an examination.

According to various embodiments, remote proctoring can be carried out utilizing each examinee's computer webcam, computer audio system, and/or other computer sensor(s) to facilitate monitoring an examinee and/or the desktop of the examinee's computer during the examination. In various embodiments, proctoring is conducted in a fashion so as to assure that the person performing the examination session has a verified identity and detect whether possible cheating is taking place. In various embodiments, remote proctoring of examinations is implemented via remote testing locations, such as examinees' respective homes, hotel rooms, and/or other suitable remote examination sites. (See, e.g., U.S. Provisional Patent Application Ser. No. 63/038,303 filed Jun. 12, 2020; incorporated herein by reference.)

In various embodiments, prior to permitting an examinee to begin an examination, the examinee must provide certain authentication information permitting a respective examination authority to authenticate the examinee's identity. Providing such authentication information can comprise, for example, taking a picture of the examinee's face and a picture of a photo identification (ID) of the examinee. In various embodiments, for example, software running on the examinee's computer facilitates photographic capture of these items. For example, an alignment guide may be provided in the field of view of a camera associated with a test taker's computer used to capture an image of his/her face. When the image of the face is within the alignment guide in the field of view, an image may be taken by the camera and provided from the computer to the examination authority. Any technique for sending the image to the examination authority may be used (e.g., electronically via a network, such as the internet, or other means). (See, e.g., U.S. Pat. No. 8,699,779; incorporated herein by reference). A similar procedure can be employed to capture and send an image of the examinee's photo ID, as well. According to various embodiments, while the process of providing authentication information by an examinee occurs prior the start of an examination, the process of authenticating the identity of the examinee by an examining authority can take place post-examination. In other embodiments, on the other hand, a suitable automated analysis protocol is employed, e.g., in a real-time analysis, to try and assess whether the picture taken of an examinee matches the photo on the examinee's photo ID,

According to various embodiments, an examinee's test-taking computer is programmed to carry out a data collection strategy, which can include, for example, taking one or more screen captures at any desired time interval(s) (e.g., periodic, regular, random, etc.), instead of recording a continuous video. In various embodiments, digital photos are made in addition to screen captures. The photos can be made at or about the same time as the screen captures, or at different times. The photos can be taken by a webcam of the test-taking computer (e.g., integrated webcam or external peripheral webcam such as a USB-connected webcam). For example, a webcam can take photos periodically or randomly, as desired, of whatever appears in its field of view (e.g., the examinee and the examinee's physical desktop space used in taking the examination). In some embodiments, plural cameras are employed with a test-taking computer during an examination period.

In some embodiments, a proctoring-data collection strategy is static throughout an examination session, while in other embodiments, it can dynamically adjust or change based on, for example, one or more selected activities under surveillance being detected. For example, once detected, the occurrence of a pre-selected event (e.g., appearance of a second person) can trigger an increase in the number of screen captures and/or photos taken per pre-determined time period for a pre-determined period of time, before reverting to the pre-event schedule.

Once made, the screen captures and/or photos can be delivered (e.g., on a storage medium or electronically transmitted) to an authority for the examination at hand. The authority, in turn, can then review them for indications of cheating. For example, such review can be carried out manually/visually by one or more humans and/or via a suitable computer-based detection method such as an artificial intelligence (“AI”) system that can automatically conduct a review and flag any suspicious findings for further review by a human.

According to various embodiments, at least about 12, about 24, about 60, about 90, or about 120 captures/pictures are made over the course of an hour-long examination period, e.g., randomly, between 30 seconds and 5 minutes each. In various embodiments, the captures/pictures are reviewed after the examination period by an authority for the examination. In some embodiments, a continuous video is additionally made during the examination period to provide for backup reference/review of any suspicious activity revealed by review of the individual captures/pictures. In such embodiments, the still captures/pictures comprise the primary means of review, with the video comprising a secondary means for review that is inspected primarily only when one or more captures/pictures indicates a more thorough and extensive review is in order due to detected suspicious activity. Additionally, a respective examinee can then be interrogated about the perceived suspicious activity. In various embodiments, a continuous video is made, but not transmitted to the examination authority unless/until it is needed for a secondary review as a result of a primary review having revealed suspicious activity.

In various embodiments, configurable settings are provided for optimization of the size(s) of image(s) captured. For example, settings can be provided to reduce the scale of the pictures of the desktop, or of the examinee, or of both. For example, the captures could initially have a resolution of 1080p, but then be reduced, for example, to 720p or 480p. Similarly, the image of the desktop of an examinee's test-taking computer may initially be 1920 by 1080, but then be scaled down, e.g., to 800 by 600. Further, frequency can be configurable, as well. The foregoing can be done manually or automatically, as desired. In this way, the resources consumed/required can be reduced, yet nevertheless be adequate for review purposes.

In various embodiments, additional image processing can be performed. For example, the color spectrum can be reduced. For example, an initial 24-bit color could be reduced downward to eight-bit color, which consumes fewer resources, yet is adequate for review purposes.

According to various embodiments, the test-taking computer can be programmed with a minimum and a maximum number of seconds or minutes during which a capture/photo will be made. In one embodiment, wherein it is desired to have a random interval, e.g., once within every two-minute period, a minimum is set at 0 seconds and a maximum is set at 120 seconds, and at a random time point within this period a photo/capture is made. In another embodiment, wherein it is desired to have a fixed interval, e.g., every minute, both the minimum and maximum could be set, for example, to 60 seconds. If it is desired to have one capture/photo randomly made within one-minute periods on average 5 minutes apart, the minimum could be set, e.g., to 270 seconds and the maximum to 330.

In various embodiments, a digital photo made of an examinee's face and a photo made of the examinee's photo identification (ID) are encrypted on the test-taking computer prior to transmission to an examination authority. Further, a unique identifier for the examinee can be embedded in, and encrypted along with the foregoing items. In this way, a single encrypted file is produced comprising three pieces of authentication information; namely, a digital photo of the examinee's face, a digital photo of the examinee's identification, and a unique identifier for the examinee (e.g., an alphanumeric identifier). The encrypted file can then be transmitted (e.g., electronically) to an authority for the examination.

### EXAMPLES

### Example 1

This example describes an exemplary flow for a remotely proctored examination session, in accordance with various embodiments of the present teachings.

1) A timed examination session is initiated by an examinee with a test-taking computer at a remote examination site.

2) A dialog box is presented to the examinee on the screen of the test-taking computer prompting the examinee to take a photo of his/her identification.

3) The examinee is presented with a live feed from a webcam of the test-taking computer. The screen of the computer is masked such that most of the screen is greyed out except for a rectangular window in the middle of the screen for framing the examinee's identification. The examinee is instructed to hold his/her identification, so it faces the webcam and fills the framing window. Once the identification is adequately framed and focused, the examinee can press a key that causes a photograph to be taken of his/her identification. Alternatively, the test-taking computer can be programmed to automatically take a photograph of the examinee's identification upon determining the identification is adequately framed and focused. The examinee can then accept the photo or press a key to repeat the photo-taking process.

4) A dialog box is presented to the examinee on the screen of the test-taking computer prompting the examinee to take a photo of his/her face.

5) An oval frame is presented to the examinee in the center of the screen of the test-taking computer, with the remainder of the screen being greyed out. The examinee is prompted to align his/her face such that it fills the area within the oval. Once adequately framed and focused, the examinee can press a key that causes a photograph to be taken of his/her face. Alternatively, the test-taking computer can be programmed to automatically take a photograph of the examinee's face upon determining it is adequately framed and focused. The examinee can then accept the photo or press a key to repeat the photo-taking process.

6) Once both the examinee represents that identification and face have been acceptably digitally photographed, the examinee is then permitted to proceed with taking the examination. Absent making adequate photos of the examinee's identification and face, the examinee may not be permitted to proceed with taking the examination. (Regarding the latter, it is recognized there may be situations where the camera doesn't function properly—the examinee may still need to be able to proceed, so identity verification and cheating detection would be handled via other means, e.g., enforcement procedures.)

7) Once the examinee begins taking the examination during the examination period, the test-taking computer makes proctoring data, including taking desktop screenshots and webcam snapshots, at random intervals.

8) The test-taking computer uploads certain collected proctoring data to a designated server in the background while the examinee continues work on the examination.

### Example 2

This example describes another exemplary flow for a remotely proctored examination session, in accordance with various embodiments of the present teachings.

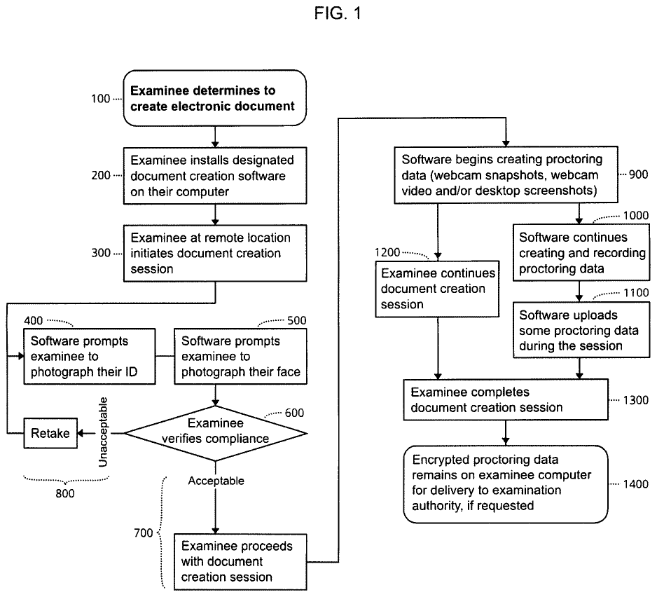

With reference to FIG. 1, as shown:
At 100, an Examinee determines to create a high-value, electronic document;
At 200, the Examinee installs designated document creation software on their computer;
At 300, the Examinee, at a remote location, initiates a document creation session;
At 400, the Software prompts the Examinee to photograph their photo ID;
At 500, the Software prompts the Examinee to photograph their face;
At 600, the Examinee verifies compliance with 400 and 500;
At 700, if the photos are acceptable, the Examinee proceeds with the document creation session;
At 800, if one or more photos are unacceptable, such photo(s) must be acceptably retaken before proceeding;
At 900, the Software begins creating proctoring data (webcam snapshots, webcam video and/or desktop screenshots);
At 1000, the Software continues creating and recording proctoring data;
At 1100, the Software uploads some proctoring data to a designated server during the session;
At 1200, the Examinee continues the document creation session during 900, 1000, 1100;
At 1300, the Examinee completes the document creation session; and,
At 1400, encrypted proctoring data remains on the examinee's test-taking computer for delivery to examination authority, but only upon and responsive to a specific request by the examination authority.

Those skilled in the art will appreciate various advantages provided by the present teachings. For example, the amount of storage required is reduced, and consequentially also the amount of bandwidth required for electronic transmission. As well, the amount of data that needs to be assessed by humans and/or AI is reduced.

The present teachings can be embodied, for example, in secure examination software such as Exam4 (Extegrity Incorporated, Half Moon Bay, CA.) See, e.g., (i) U.S. patent application Ser. No. 16/807,080 filed Mar. 2, 2020, entitled, “SYSTEMS AND METHODS FOR PROVIDING TOOLS FOR THE SECURE CREATION, TRANSMITTAL, REVIEW OF, AND RELATED OPERATIONS ON, HIGH VALUE ELECTRONIC FILES”; and, (ii) U.S. Pat. No. 9,953,175, entitled, “SYSTEMS AND METHODS FOR DETECTING SUBSTITUTION OF HIGH-VALUE ELECTRONIC DOCUMENTS”; each of which is incorporated herein by reference.

All references set forth herein are expressly incorporated by reference in their entireties for all purposes.

While the principles of the present teachings have been illustrated in relation to various exemplary embodiments shown and described herein, the principles of the present teachings are not limited thereto and include any modifications, alternatives, variations and/or equivalents thereof.

1-7. (canceled)

8. A method for authentication and monitoring of a remote examinee during creation of a high-value electronic document for a computer-based examination, the method comprising:
(a) before the examination, capturing, by a test-taking computer of the examinee, authentication data comprising (i) a digital photograph of the examinee and (ii) a digital photograph of a photo identification (ID) showing the examinee, and transmitting the authentication data to an authority for the examination;
(b) during the examination, capturing, by the test-taking computer, still-image screenshots of a screen-display of the test-taking computer at non-periodic time intervals that are not fixed; and
(c) transmitting the screenshots to a designated server of the examination authority for review.

9. The method of claim 8, wherein the non-periodic intervals are generated randomly between a minimum interval and a maximum interval.

10. The method of claim 8, wherein the screenshots are generated using a random-number function producing a time value between the minimum interval and maximum interval.

11. The method of claim 8, further comprising detecting a pre-selected activity under surveillance and, responsive to detecting the activity, temporarily increasing a frequency at which screenshots are captured.

12. The method of claim 8, further comprising reducing at least one of a resolution or a color depth of the screenshots prior to transmission.

13. The method of claim 8, further comprising capturing photos of the examinee by a camera of the test-taking computer during the examination.

14. The method of claim 8, further comprising capturing proctoring data by a mobile device of the examinee separate from the test-taking computer.

15. The method of claim 8, further comprising encrypting the authentication data with a unique identifier of the examinee to form a single encrypted authentication package prior to transmission.

16. The method of claim 8, further comprising recording, by the test-taking computer, continuous or intermittent video during the examination and storing the video solely in encrypted form on the test-taking computer unless later requested by the examination authority.

17. A method for authentication and monitoring of a remote examinee during creation of a high-value electronic document for a computer-based examination, the method comprising:
(a) before the examination, capturing, by a test-taking computer of the examinee, authentication data comprising a digital photograph of the examinee and a digital photograph of a photo identification (ID) showing the examinee;
(b) during the examination, capturing proctoring data by the test-taking computer comprising
(i) still-image screenshots of a screen-display of the test-taking computer, and
(ii) at least one of photos or video of the examinee or an environment of the examinee, wherein the screenshots of (i) are captured at non-periodic intervals that are not fixed; and
(c) transmitting at least the screenshots of step (b) (i) to a designated server of the examination authority for review.

18. The method of claim 17, wherein the non-periodic intervals are generated randomly using a minimum interval and a maximum interval.

19. The method of claim 17, wherein the screenshots are created responsive to a random selection of a time value between the minimum interval and maximum interval.

20. The method of claim 17, further comprising detecting a pre-selected activity under surveillance and, responsive to detecting the activity, increasing a frequency of creating screenshots or photos.

21. The method of claim 17, wherein the pre-selected activity comprises detection of a second person entering a physical environment of the examinee.

22. The method of claim 17, wherein the still-image screenshots of the screen-display are scaled or color-reduced to reduce resource usage.

23. The method of claim 17, further comprising encrypting the authentication data together with a unique identifier of the examinee to form a single encrypted authentication package.

24. The method of claim 17, further comprising recording video by the test-taking computer during the examination and storing the video solely on the test-taking computer in encrypted form unless later specifically requested by the examination authority.

25. The method of claim 17, further comprising capturing supplemental proctoring data by a mobile device of the examinee that supplements the proctoring data captured by the test-taking computer.

26. The method of claim 25, wherein the proctoring data further comprises audio captured by a microphone of the test-taking computer or of the mobile device.

27. The method of claim 17, wherein the still-image screenshots are created in response to at least one trigger event comprising an application-level event on the test-taking computer.
